(19) United States
(12) Patent Application Publication
(10) Pub. No.: US 2026/0100190 A1
(43) Pub. Date: Apr. 9, 2026

(54) CUSTOMIZED, PERSONALIZED, AND EXTENDABLE LARGE LANGUAGE MODEL (LLM)-ENHANCED VIRTUAL ASSISTANTS

(71) Applicant: Zoom Communications, Inc., San Jose, CA (US)

(72) Inventors: Zheng Chen, Bellevue, WA (US); Ashley Alexandra Hellmann, San Francisco, CA (US); Gareth Paul Jones, Novato, CA (US); Wei Li, Cupertino, CA (US); Ross Douglas Mayfield, Palo Alto, CA (US); Stephen George Newton, San Jose, CA (US); Rachita Audhesh Singh, Westlake, OH (US); Jeffrey William Smith, Layton, UT (US); Bo Yan, Sammamish, WA (US)

(73) Assignee: Zoom Communications, Inc., San Jose, CA (US)

(21) Appl. No.: 19/195,146

(22) Filed: Apr. 30, 2025

Related U.S. Application Data
(60) Provisional application No. 63/704,326, filed on Oct. 7, 2024.

(51) Int. Cl. G10L 15/22; H04N 7/15

(52) U.S. Cl. CPC G10L 15/22; H04N 7/15

(57) ABSTRACT

Techniques for customized, personalized, and extendable large language model (“LLM”)-enhanced virtual assistants are provided. In an example method, a computing system receives first information about one or more data sources. The computing system receives, from a first client device, an expression. The computing system accesses the one or more data sources based on the expression to retrieve contextual information based on the expression. The computing system receives additional information from one or more services, where at least one service of the one or more services is accessed using an integration interface. The computing system receives, from an LLM, a response to a prompt, the prompt based on the expression, the contextual information, and the additional information. The computing system outputs, to the first client device, the response.

### CROSS-REFERENCE TO RELATED APPLICATIONS

This application claims priority to provisional application U.S. Ser. No. 63/704,326 entitled “Customized, Personalized, And Extendable Large Language Model (LLM)-Enhanced Virtual Assistants” and filed on Oct. 7, 2024, the entire disclosure of which is incorporated herein by reference for any purpose.

### FIELD

The present application generally relates to virtual assistants, and more particularly relates to customized, personalized, and extendable large language model (LLM)-enhanced virtual assistants.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices, according to some aspects of the present disclosure.

FIG. 2 shows an example system in which a video conference provider provides videoconferencing functionality to various client devices, according to some aspects of the present disclosure.

FIG. 3 shows an example user interface that may be used in some example systems configured for providing customized, personalized, and extendable LLM-enhanced virtual assistants, according to some aspects of the present disclosure.

FIG. 4 shows an example system for customized, personalized, and extendable LLM-enhanced virtual assistants, according to some aspects of the present disclosure.

FIG. 5 illustrates an example implementation of the AI virtual assistant, according to some aspects of the present disclosure.

FIG. 6 depicts a graphical user interface (“GUI”) that may be used in some example virtual assistant implementation, according to some aspects of the present disclosure.

FIG. 7 shows another example of a UI for providing customized, personalized, and extendable LLM-enhanced virtual assistants, according to some aspects of the present disclosure.

FIGS. 8A-8C show example GUIs involving first-or third-party services for customized, personalized, and extendable LLM-enhanced virtual assistants, according to some aspects of the present disclosure.

FIG. 9 shows an example GUI for configuring a custom dictionary for customized, personalized, and extendable LLM-enhanced virtual assistants, according to some aspects of the present disclosure.

FIG. 10 shows an example GUI for configuring templates for customized, personalized, and extendable LLM-enhanced virtual assistants, according to some aspects of the present disclosure.

FIGS. 11A-11B show another example GUI for configuring templates for customized, personalized, and extendable LLM-enhanced virtual assistants, according to some aspects of the present disclosure.

FIG. 12 shows a flowchart of an example method for providing customized, personalized, and extendable LLM-enhanced virtual assistants, according to some aspects of the present disclosure.

FIG. 13 shows example of a GUI for a virtual assistant customization application for configuring customized, personalized, and extendable LLM-enhanced virtual assistants, according to some aspects of the present disclosure.

FIG. 14 shows an example computing device suitable for use in example systems or methods for providing customized, personalized, and extendable LLM-enhanced virtual assistants, according to some examples of the present disclosure.

### DETAILED DESCRIPTION

Examples are described herein in the context of techniques for implementing customized, personalized, and extendable LLM-enhanced virtual assistants. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

As video conferencing and other digital communication technologies continue to become a more and more significant part of enterprise and personal communications, additional technologies that complement or supplement the core functionality provided by video conference providers are increasingly prevalent. One such example is the virtual assistant, which can be added to the user interface for video conferencing, chat, email, whiteboarding, and other applications. For example, the virtual assistant can be provided using a chat-like interface that can simulate the experience of having a conversation with a real, human assistant.

In a typical use case, a user may need to perform any number of tasks in concert with ongoing digital communications. For instance, a user may need to take action on something discussed during a video conference or chat conversation, such as creating, reading, or editing a document. However, for some tasks, the user may lack the time or the expertise to quickly address them. Thus, the user may seek assistance with those tasks from an artificial intelligence (“AI”)-based virtual assistant (hereinafter “virtual assistant”). A virtual assistant may be programmed to receive a text input from the user, interpret that input to identify one or more actions to perform, and a result to provide to the user.

To enable the virtual assistant to effectively understand and handle a request from the user, a virtual assistant may be backed by an agentic framework including a task coordinator function that coordinates actions of a query processor, one or more large language models (“LLM”) acting as “agents,” one or more identified tasks, available functionality to address particular tasks, and interfaces to those functionalities. It may also track the completion status of various tasks and, when complete, respond to the user about the result. Such an approach can enable the virtual assistant to go beyond answering questions using an LLM to actually performing actions through the available functionality and interfaces.

However, existing virtual assistant implementations are unable to perform the full spectrum of tasks that are typically requested in a domain-specific context because agentic frameworks and their associated components are designed for broad applicability and lack the training, vocabulary, knowledge base, functionality, and interfaces to perform domain-specific tasks. For example, while existing virtual assistants may be able to answer questions about general knowledge or to perform tasks using publicly available application programming interfaces (“APIs”), they cannot answer questions about information in confidential, locally stored documents, use vocabulary that is specific to a particular organization or profession, or perform tasks using functionality that is only accessible through private networks. Consequently, in many contexts, existing virtual assistant implementations are of limited use when using in connection with digital communication applications.

Customized, personalized, and extendable LLM-enhanced virtual assistants according to this disclosure can be used to overcome these challenges. For example, a user interface may be provided for adding custom data sources, services, templates, and other customizations to a virtual assistant that are specific to a particular organization, domain, geography, etc. The virtual assistant is accordingly customized, personalized, and/or extended in concert with the particular context in which it will be used, significantly increasing its value to users while not requiring any exposure of confidential or private information or services.

The following non-limiting example is provided to introduce certain concepts. In the example method, a computing system such as a video conference provider receives information about certain data sources or templates. For example, the computing system may provide a virtual assistant customization application (e.g., an “AI Studio”) that can be accessed by client devices to configure an LLM-enhanced virtual assistant application. Using the customization application, a user or administrator can configure data sources such as a glossary or dictionary that provides domain-specific context for various words, phrases, and concepts. Similarly, the user or administrator can create or edit a template that includes specific instructions for generating responses to certain queries, such as response formats, added context, length, and so on.

With the virtual assistant thus configured, the computing system later receives, from a client device, an expression such as a query or instruction to perform a task. The computing system accesses the configured data sources based on the expression to retrieve contextual information based on the expression. For example, the LLM can use a context-retrieval framework such as a retrieval-augmented generation (“RAG”) framework or an agentic framework to access the data sources and add additional information to the context window of the LLM preparing the response to the expression. The computing system also receives additional information from a service such as service accessed using a web-based API or other integration interface. The available services can likewise be configured using the virtual assistant customization application. For example, if the expression is an instruction to perform a task, such as to create or access a document, the API can be used to instantiate and populate a new document or to access an existing document. The retrieved information can likewise be added to the context window of the LLM preparing the response to the expression.

The computing system then receives, from an LLM, a response to a prompt based on the expression and the various additional information added to the context window of the LLM as well as the template. The LLM then generates a response in accordance with the template. For example, if the expression is an instruction to perform a task, the template may specify a particular output format to use to report completion of the task including markup (e.g., HTML), links, information about the completed task, and so on. The response is then output to the client device, which can display it using a suitable user interface, such as a chat-like interface.

Consider an example of a customized, personalized, and extendable LLM-enhanced virtual assistants for use in healthcare. Customizations may include tailored lexicon or healthcare dictionaries added using the AI virtual assistant configuration studio. The virtual assistant configuration application can further be used to extend the knowledge base to include internal patient management systems or external medical databases. Personalization may include personal coaching features that can use user interactions to identify patterns to offer personalized feedback or guidance to healthcare providers. Extensions may include integration with third-party APIs provided by electronic medical records (EMR) providers, other healthcare facilities, diagnostic centers, and so on.

Another example of a customized, personalized, and extendable LLM-enhanced virtual assistants can be used for education. Customizations may include student engagement analytics added using the virtual assistant configuration application. Personalization may include generation of per-lecture faculty engagement feedback or detailed personalized coaching for education providers. Extensions may include integration with third-party APIs (or other integration interfaces) provided by educational services providers, other educational facilities, and so on. Educational service providers may include online learning platforms, learning management systems, textbook publishers, and so on.

Yet another example of a customized, personalized, and extendable LLM-enhanced virtual assistants involves using the enhanced virtual assistants in a variety of software contexts. For example, instead of being embedded in a particular client application, the techniques disclosed herein can be used to using the enhanced virtual assistants along with other software applications. For example, the enhanced virtual assistant can be used effectively with a first video conference client application or a second video conference client application. In some examples, this can be enabled using extensibility frameworks provided by the respective video conference client applications.

In general, example systems and methods according to this disclosure can be used to create, maintain, or operate customized and personalized LLM-enhanced virtual assistants for a variety of purposes, in addition to these illustrative examples. For example, LLM-enhanced virtual assistants for healthcare, education and/or tutoring, customer service, financial advising, legal research assistance, recruitment, travel planning, e-commerce or shopping, and so on can be generated using a similar approach.

Systems and methods according to the present disclosure provide significant improvements in the technical field of virtual assistants. In addition to addressing the technical challenges described above, the techniques of the present disclosure can promote enhanced interoperability across disparate systems. For instance, through the integration with third-party APIs (or other integration interfaces), virtual assistants can perform tasks that span multiple platforms without requiring extensive manual configuration. Additionally, accessibility can be improved through, for example, support for localized customization, such as language-specific or disability-specific adjustments, ensuring virtual assistants can be used across diverse operational contexts. Computers are improved through reduced consumption of computational resources during virtual assistant operations. For example, the use of RAG frameworks or agentic task coordination can reduce the computational overhead that may be associated with LLM use by narrowing the scope of the information that must be processed during response generation. Additionally, the modular approach to customization enabled through the virtual assistant customization application can result in more efficient utilization of computational resources by ensuring that only the components and services required to address a particular query or instruction are used. The modular approach can also contribute to improved scalability of the system.

These illustrative examples are given to introduce the reader to the general subject matter discussed herein and the disclosure is not limited to these examples. The following sections describe various additional non-limiting examples of systems and methods for providing customized, personalized, and extendable LLM-enhanced virtual assistants.

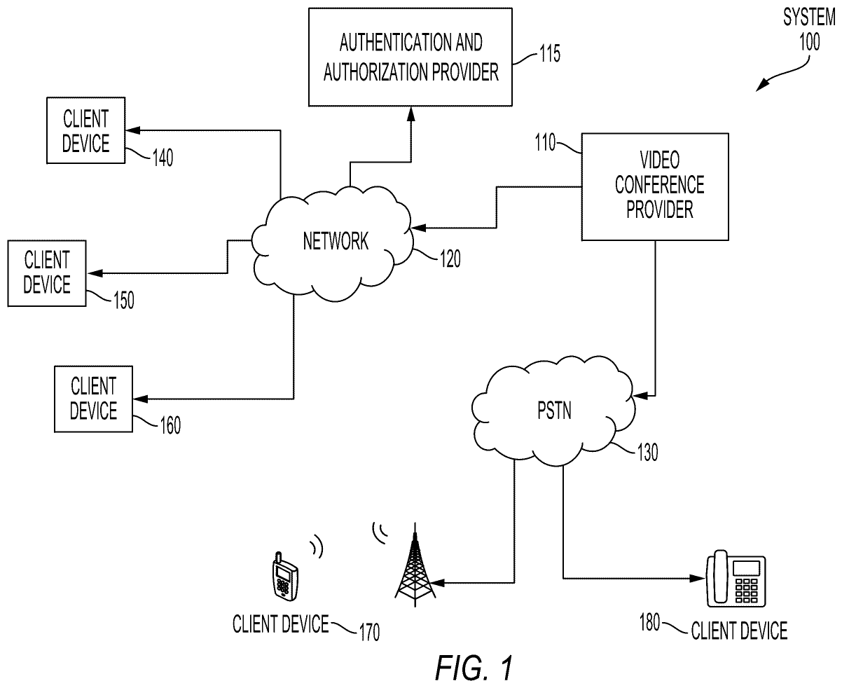

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

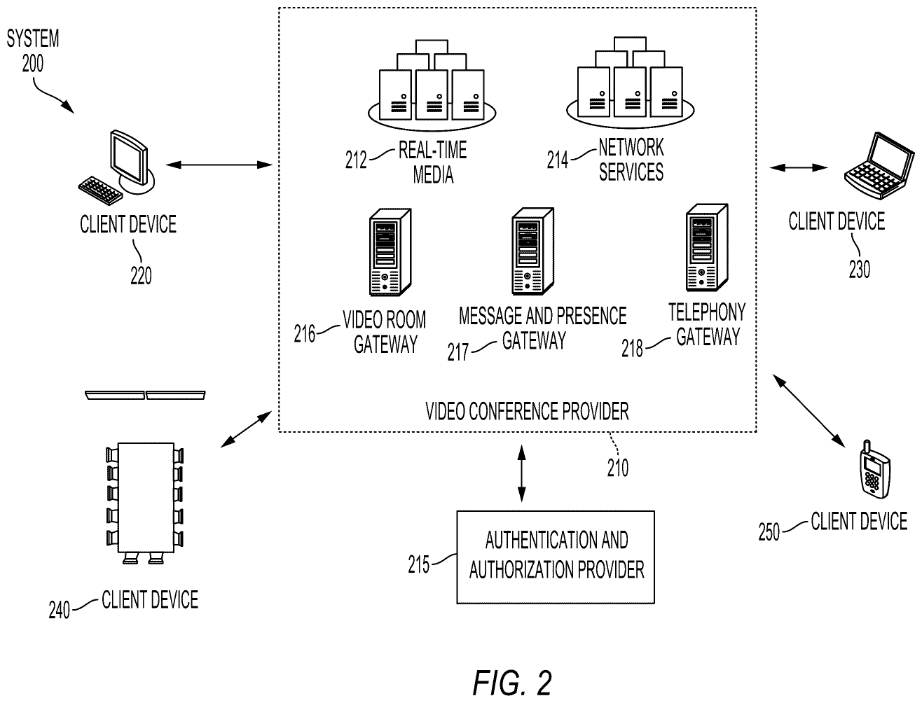

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices'participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

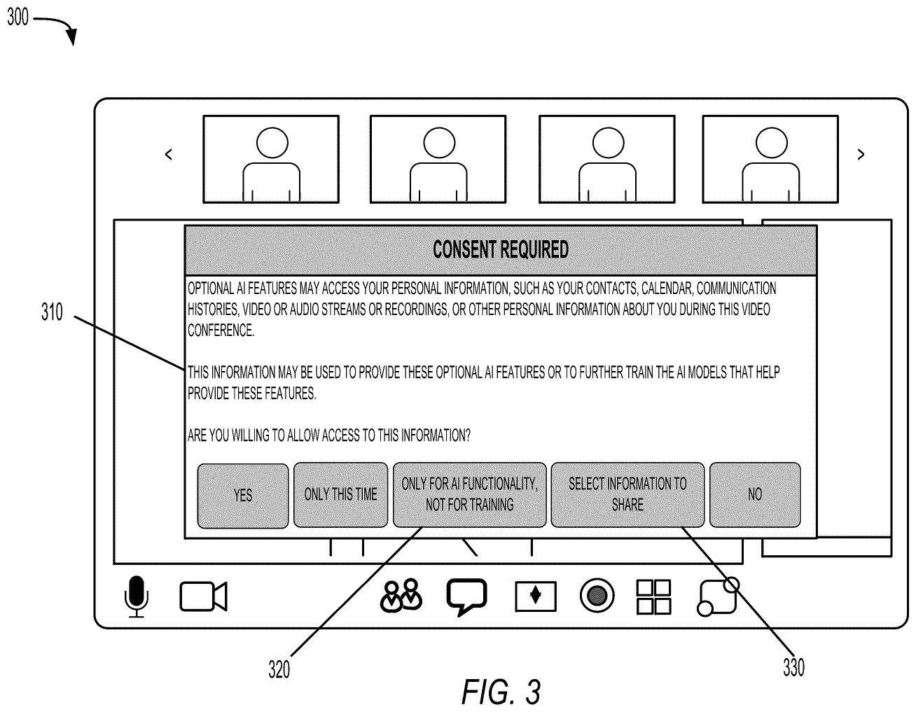

Turning next to FIG. 3, FIG. 3 shows an example user interface 300 that may be used in some example systems configured for providing customized, personalized, and extendable LLM-enhanced virtual assistants, according to some aspects of the present disclosure. In some examples according to the present disclosure, a user may select an option to use one or more optional AI features available from the virtual conference provider 302. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 3, a user has engaged in a video conference and has selected an option to use an available optional AI feature. In response, the GUI has displayed a consent authorization window 310 for the user to interact with. The consent authorization window 310 informs the user that their request may involve the optional AI feature accessing multiple different types of information, which may be personal to the user. The user can then decide whether to grant permission or not to the optional AI feature generally, or only in a limited capacity. For example, the user may select an option 320 to only allow the AI functionality to use the personal information to provide the AI functionality, but not for training of the underlying AI models. In addition, the user is presented with the option 330 to select which types of information may be shared and for what purpose, such as to provide the AI functionality or to allow use for training underlying AI models.

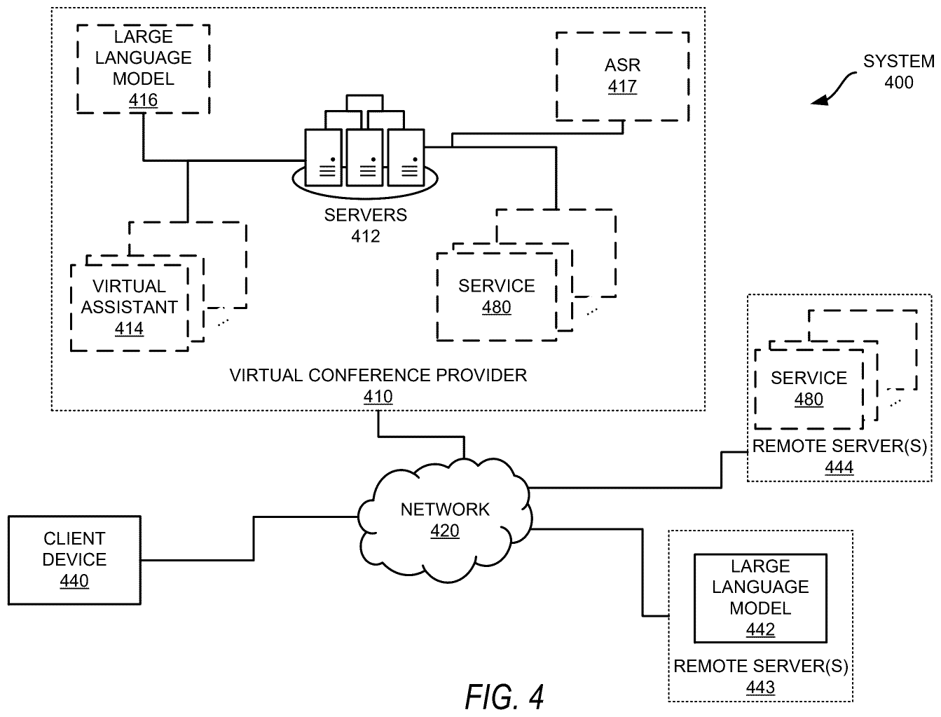

Referring now to FIG. 4, FIG. 4 shows an example system 400 for customized, personalized, and extendable LLM-enhanced virtual assistants, according to some aspects of the present disclosure. In this example, the system 400 includes a client device 440, a virtual conference provider 410, one or more remote servers 443 that host a LLM 442, and one or more remote servers 444 that host services that may invoked by an AI virtual assistant 414.

The client device 440 is communicatively coupled with virtual conference provider 410 over a network 420. The network 420 may include the Internet, public networks, private networks, or combinations thereof. Virtual conference provider 410 is typically a server or collection of servers, including a combination of privately or cloud-hosted devices. Virtual conference provider 410 may be similar, in some respects, to the video conference providers 110, 210 described above with respect to FIGS. 1 and 2.

The client device 440 may be any type of device capable of executing the appropriate client software for providing customized, personalized, and extendable LLM-enhanced virtual assistants. For example, the client device 440 may be a laptop, desktop, smartphone, tablet, internet protocol (IP) phone, and so on. The client device 440 may execute virtual conference client software, a Unified Communications as a Service (“UCaaS”) platform client software, a virtual assistant customization application, and so on.

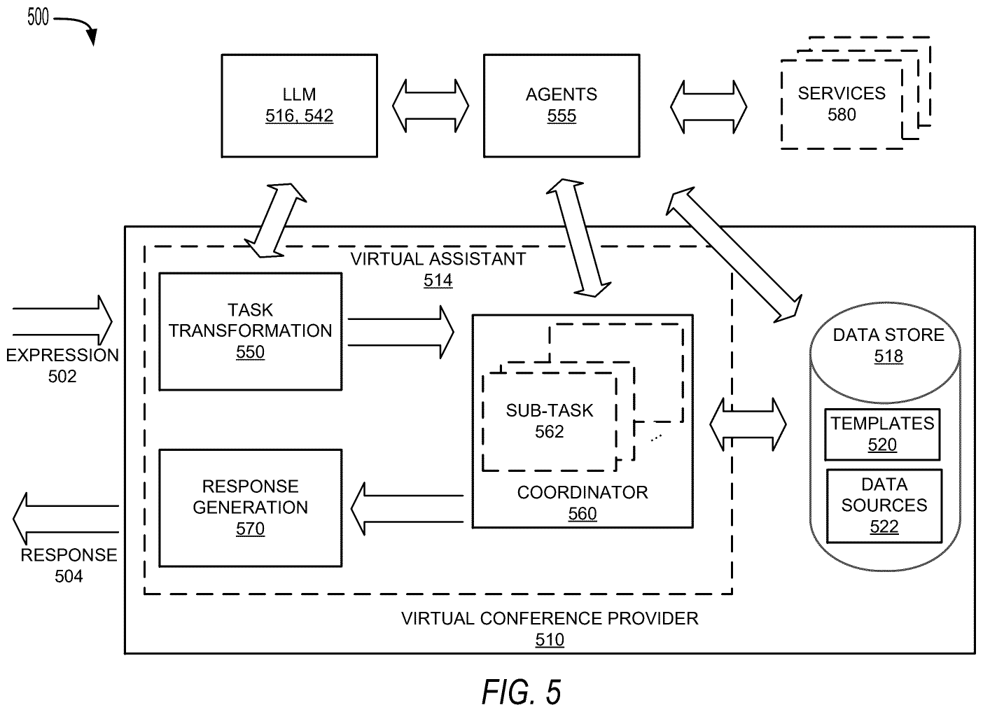

The virtual conference provider 410 also provides one or more servers 412 that provide AI virtual assistants 414 that may be allocated to requests received from users via their respective client device, such as client device 440, and one or more services 480 that may be invoked by the AI virtual assistants 414. In addition, the virtual conference provider 410 maintains its own LLM 416 that may be employed by a virtual assistant 414 instead of (or in addition to) the LLM 442 hosted by the remote server 443. The AI virtual assistant 414 implementation shown in example system 400 is an example of an agentic framework that can be used to generate responses to expressions received from client devices. The LLMs 416, 442 can act as “agents” configured to perform certain tasks or sub-tasks managed by a coordinator agent. An example implementation of such an agentic framework is shown in FIG. 5, which is discussed in more detail below.

To obtain assistance from an AI virtual assistant 414, a user of the client device 440 may interact with the AI virtual assistant 414 via a web page or client application and request assistance by typing in or speaking an expression including a task for the AI virtual assistant 414 to perform or a query for the AI virtual assistant 414 to answer. Alternatively, the expression can be indirectly provided. The AI virtual assistant 414 can monitor ongoing digital communications an infer tasks or queries, which it can then respond to as if it is a participant in the digital communication. Monitoring of ongoing digital communications in this regard is subject to the explicit user consent of all participants.

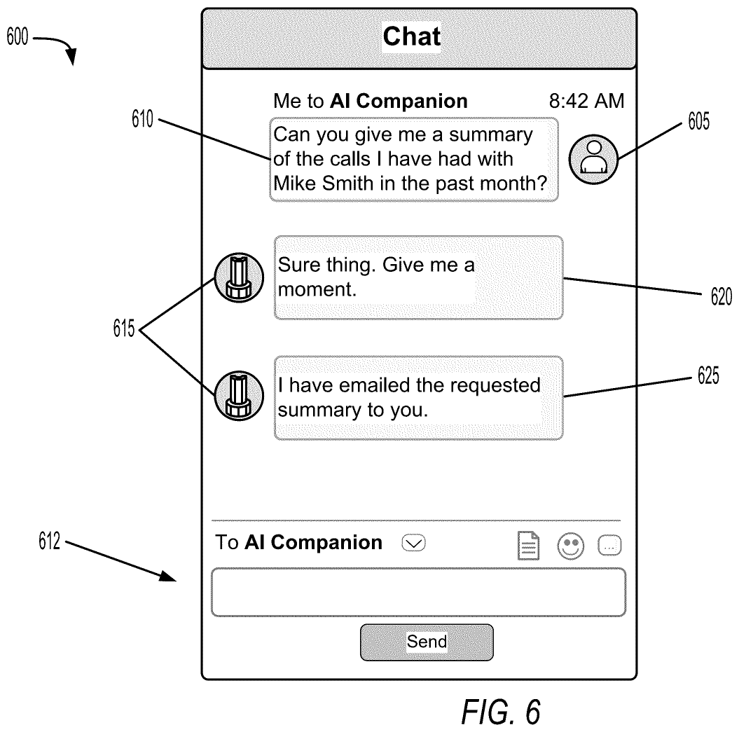

A typical example of an interaction with the AI companion is shown in FIG. 6, according to some aspects of the present disclosure. FIG. 6 depicts a graphical user interface (“GUI”) 600 that may be used in some example virtual assistant implementations, according to some aspects of the present disclosure. In GUI 600, a user, represented by icon 605 is engaged in a chat session with a virtual assistant named “AI Companion.” The virtual assistant, as depicted in GUI 600, may be a frontend user interface for the AI virtual assistant 414 backend. For example, the user icon 605 may start a private chat with the virtual assistant represented by icon 615 and output expressions (e.g., queries or instructions) to it via the chat interface for processing by the AI virtual assistant 414.

In this example, the user has input a task 610 for the virtual assistant to provide “a summary of the calls I have had with Mike Smith in the past month” using text input controls 612. In some examples, after entering the task, but before it has been provided to the AI virtual assistant 414, the GUI has displayed a consent authorization for the user to interact with (not shown). The consent authorization informs the user that their request may involve the AI virtual assistant 414 accessing multiple different types of information, which may be personal to the user. The user can then decide whether to grant permission to the AI virtual assistant 414 generally or only for this request. Alternatively, the user can decline to provide permission, which may prevent the AI virtual assistant 414 from accessing the user's personal information. In this example, the virtual assistant outputs a first reply 620 indicating that processing will take some time, followed by a second reply 625 reporting the outcome of the task. In this example, the second reply 625 may be based on a template.

Returning to FIG. 4, expressions may be questions, requests for information, instructions to perform one or more actions, or a combination of these. In examples that allow tasks to be spoken, the client device or the virtual conference provider 410 may provide automatic speech recognition (“ASR”) 417 to convert the spoken task into text that can be received and processed by the AI virtual assistant 414. In some examples, the AI virtual assistant 414 may provide such ASR functionality, though other examples may employ ASR 417 to generate a textual representation of the task that is then passed to the AI virtual assistant 414.

The AI virtual assistant 414 receives a task or query from the client device 440 and interacts with an LLM 416, 442 to break the task down into sub-tasks that can be individually processed, identify the order of operation for the sub-tasks, and identify additional information that is needed from the client device 440. Each of the sub-tasks may invoke one or more services 480, either locally provided by the virtual conference provider 410 or by one or more remote servers, e.g., remote server(s) 444, to take actions or obtain information as a part of the AI virtual assistant handing the task. Sub-tasks may also be performed by an LLM 416, 442 acting as a specialized agent and the services 480 may include an LLM 416, 442 acting as a specialized agent. The sub-tasks are ordered and coordinated by coordinator functionality that receives ordering information from the LLM 416, 442. The coordinator can also aggregate the information received from the sub-tasks as they operate and provide the information to response generation functionality that can generate a final response to the client device once the task has been completed.

The services 480 may include any number of functionalities that may be provided by the virtual conference provider 410 or remote servers 444. For example, a task may be to setup a meeting with another person. Sub-tasks generated for the task may include identifying contact information for the person, determining free times on their calendar, generating a virtual conference meeting identifier and passcode, and generating a meeting agenda and invitation. Thus, the services 480 involved may include an employee directory or email directory service, a calendar service, a virtual conference service, and an LLM (e.g., LLM 416, 442) to generate a title and agenda for the meeting. Other suitable services may include document management systems, search engines, support ticket systems, telephone systems, chat systems, or music or video playback systems. However, any suitable service may be employed according to different examples.

By employing a LLM to help break down the task received from the client device, and by using the LLM to assist with executing the sub-tasks, the AI virtual assistant 414 can efficiently and accurately handle tasks on behalf of various users. In addition, the use of an LLM allows the user to provide a natural language description of a task to be performed and to interact with the AI virtual assistant in an intuitive manner to obtain the desired result.

Referring now to FIG. 5, FIG. 5 illustrates an example implementation 500 of the AI virtual assistant 414, according to some aspects of the present disclosure. In particular, the AI virtual assistant 414 is shown implemented using an agentic framework. However, it should be stressed that the AI virtual assistant 414 can be implemented using any suitable approach for generating responses to expressions and performing tasks. For example, the AI virtual assistant 414 may be implemented using, additionally or in combination, retrieval-augmented generation (“RAG”), rule-based processing, reinforcement learning mechanisms, among other possible approaches.

The agentic framework depicted in FIG. 5 includes one or more components acting as “agents” (agents 555) configured to perform one or more respective general or specialized tasks. The agentic framework includes a coordination mechanism (coordinator 560) that manages interactions between the one or more agents based on the expression to generate a response. The response can be generated by the agentic framework using the expression, contextual information gathered by the agents, additional information obtained from one or more services, and a template that can characterize input and/or output formats. To do this, the coordination mechanism for the agentic framework can be configured to first determine an intent associated with the response. Then, at least one agent, typically including an LLM, can be selected based on the intent and the contextual information. The selected agents can then be instructed to execute tasks or sub-tasks to retrieve or generate additional content. The response can then be generated using the template and the additional content retrieved. These components will be described in more detail below.

The virtual conference provider 510, similarly to the virtual conference provider 410, includes an AI virtual assistant 514 implemented using an agentic framework that includes task transformation 550 functionality, a coordinator 560 that can coordinate the execution of one or more sub-tasks 562 by one or more agents 555, and response generation functionality 570 that can generate a response to a user after completion of a task defined by expression 502. As discussed above, the virtual conference provider 510 also provides one or more services 580 that may be invoked by the agents 555 to perform one or more sub-tasks 562. In addition, the virtual conference provider 510 includes a data store 518 that includes information about the available services at the virtual conference provider 510, information about additional data sources 522 configured using a virtual assistant customization application, templates 520, and other customizations.

While the example virtual assistant 514 implementation is shown as a component of the virtual conference provider 510 (or, e.g., the virtual conference provider 410), the virtual assistant 514 may likewise be a component of any suitable system or a standalone system. For example, the virtual assistant 514 may be a component of a gaming or business intelligence system that integrates virtual assistant functionality into other applications. As a standalone example, the virtual assistant 514 may be used to provide a chat-like interface as a web application that can receive expressions (e.g., queries or tasks) and provide responses.

When an expression 502 such as a query or task instructions is received from a remote client device, e.g., client device 440 of FIG. 4, the AI virtual assistant 514 employs its task transformation functionality 550 to provide the expression 502 to the LLM 516, 542 and request the LLM 516, 542 to break down the task into sub-tasks 562, to provide an ordering for the sub-tasks 562, and to identify additional information to be requested to perform the requested task or query contained in expression 502. The task transformation functionality 550 may provide a series of text prompts to the LLM 516, 542 to invoke this functionality such as:
Prompt 1: I have a task that needs to be performed, and I have some questions for you about the task. Here is the task: [Task description]
Prompt 2: Please provide the sub-tasks that need to be performed to accomplish this task
Prompt 3: Please identify the ordering of the sub-tasks, including whether any sub-task is not dependent on another sub-task to complete.
Prompt 4: Please identify information that is not included in the task that may be needed to complete one or more of the sub-tasks.
   In response to the prompts, the LLM 516, 542 provides one or more sub-tasks 562 to be performed, as well as the ordering of those sub-tasks 562, and additional information to be requested from the user.

If additional information is requested, the task transformation functionality 550 may output a message to the user identifying the additional information that is needed. After receiving the information, the task transformation functionality may issue one or more additional prompts to the LLM 516, 542 that provides the additional information and requests any additional sub-tasks 562 or further information that may be needed. This continues until no additional information is required from the user. For example, if the user sends a task to “Summarize my conversations last week about project X to help me prepare for my 11 am meeting,” the AI virtual assistant 514 may issue the prompts identified above.

In addition, the AI virtual assistant 514 may also request additional information from the user. For example, to help the AI virtual assistant 514 identify relevant content to access and summarize, it may ask the user to identify which services the user has engaged with about Project X, such as email chats, meetings, or phone calls. The user may then respond, using natural language, to identify those services, or it may select one or more options from a GUI window. The AI virtual assistant may then construct an additional prompt to the LLM 516, 542 to identify those services.

In some cases, the AI virtual assistant 514 may instead identify the user's email inbox and chat channels the user is a member of, such as by accessing the user's profile, by default and not request additional information. Similarly, to obtain information about meetings, the AI assistant may await information from the LLM 516, 542 in response to one or more prompts, which may then identify a calendar service and instructions regarding how to interface with the calendar service, such as via an API or messaging interface.

Similarly, the AI virtual assistant 514 may use one or more configured data sources 522 persisted by the data store 518 or accessible via the services 580 (e.g., via an API). For example, the one or more data sources 522 may include information about a data history of the user, provided the user has given explicit consent for such access. The data history of the user may include, for example, records of previous interactions with the AI virtual assistant 514. Some examples may enable users to provide an “infinite” data history record to the AI virtual assistant 514, referring to all interactions with the AI virtual assistant 514 that have occurred (excepting portions that have been deleted or designated as not part of the data history). Inclusion of the entire data history for a user can enable personalized, context-aware responses by using long-term preferences, patterns, and prior expressions and responses.

Another example of the one or more data sources includes a dictionary including a number of expressions and associated contexts. For instance, in a simple example, the dictionary may include words or phrases and their definitions. In a more complex example, the dictionary may include multi-word expressions or concepts mapped to domain-specific meanings, usage constraints, or usage examples. In the example of the medical domain, the dictionary may map the phrase “heart block” to a type of cardiac conduction disorder, distinguishing it from unrelated uses of “heart” or “block” in non-medical contexts.

After the sub-tasks 562 have been identified, they are provided to the coordinator 560 along with the ordering of the sub-tasks 562. The coordinator 560 may be an LLM or use the LLM 516, 542. The coordinator 560 may be prompted to coordinate the execution of the sub-tasks 562 according to a determined ordering using the available agents 555. The agents 555 may be or may use the LLM 516, 542. In some examples, the agents 555 include specialized LLMs that are fine-tuned or configured for particular applications or types of sub-tasks. The coordinator 560 can select particular agents for certain sub-tasks or may use the LLM 516, 542 as agent for sub-tasks without particular specialization.

Some sub-tasks 562 may be dependent on the completion of other sub-tasks 562, and thus they must be executed in order. However, some sub-tasks 562 may not be dependent on other sub-tasks 562 and may be executed at any time, or in parallel with other sub-tasks 562. Further, in some cases the LLM 516, 542 can indicate that additional information is needed from the user, which the AI virtual assistant 514 may then communicate to the user, such as via the chat functionality shown in FIG. 6 and described above. After obtaining the additional information, the AI virtual assistant 514 may provide the additional information to the LLM 516, 542, which may then identify one or more additional sub-tasks.

For example, to assist the user with the summarization task requested above, the sub-tasks 562 may include obtaining chat logs from one or more chat channels, obtaining emails from the user's email system, obtaining meeting information from the user's calendar, obtaining transcripts for relevant meetings, and so forth. Likewise, the sub-tasks 562 may involve accessing the one or more configured data sources or services 580, as described in further detail below.

To execute a sub-task, the coordinator 560 accesses the data store 518 and obtains information about the available agents 555 and services 580, as well as templates 520 to be used for prompting the agents 555. In this example, the data store 518 includes a directory of the available agents 555 and services 580 that includes a textual description of the capabilities of each agent and service as well as instructions regarding how to invoke those capabilities. For services hosted by remote servers 444, the coordinator 560 may request such information from the remote servers 444. The instructions regarding how to invoke service functionality may include a description of an API, one or more functions provided by the API and a description of what each function does and what information it needs and what information it outputs, or a format for a messaging interface or sequence of messages for one or more such functionalities. And while this example involves an API or messaging interface, other interfaces may be used as well, such as inter-process communication (“IPC”) or a query interface for a database management system, such as structured query language (“SQL”).

In some cases, the LLM 516, 542 may also specify an order for one or more sub-tasks or it may identify dependencies between sub-tasks. For example, if five sub-tasks are identified, the LLM 516, 542 may specify the order the sub-tasks should be executed in and whether the output of one or more sub-tasks should be used as an input to another sub-task. For example, the LLM 516, 542 may identify five sub-tasks and specify the order as being sub-tasks one and two to be performed first, followed by sub-task three, followed by sub-task four that takes the output of sub-tasks one and three as input, and finally sub-task five that takes the output of sub-tasks two and four as input. The coordinator 560 may obtain the sequencing information in addition to the identified sub-tasks and use the sequencing information to execute the sub-tasks in the proper sequence and with the appropriate inputs.

After obtaining the information about the available services 580, the coordinator 560 prompts an agent of the agents 555 by identifying a particular sub-task 562 and the descriptions of the available services 580 to determine which service(s) should be invoked to handle the sub-task 562. Based on the sub-task and the descriptions of the available services 580, the selected agent identifies one or more services that closely match the sub-task and provides an identification of the service(s) to the coordinator 560. The agent may also identify an interface, e.g., an API or formatting for messages to be sent to the service, to perform the sub-task. In some examples, the coordinator 560 can then use the response from the agent to invoke the appropriate service(s) 580, such as by calling the corresponding API or generating and sending one or more messages to the task, whether hosted by the virtual conference provider 510 or a remote server 444, to obtain information or perform an action. The coordinator 560 can then process each of the sub-tasks 562 in a similar way according to the order defined by the LLM 516, 542. Further, in some examples, the selected agent itself may perform the operation specified by the sub-task 562, such as by directly interacting with an appropriate service or services according to the description of the services and instructions regarding how to invoke functionality of those services stored in the data store 518. For example, the agent may generate and output a message or database command to a service 580 to obtain information from the service 580. In some cases, agents may perform sub-tasks without recourse to the services 580.

As the sub-tasks 562 execute and complete, the coordinator 560 accumulates information about each completed sub-task 562, such as information obtained or actions performed, reported by the respective agents 555 (or LLM 516, 542). For example, for the user's request for a summary of his conversations about Project X, the various sub-tasks may provide one or more emails, chat logs, meeting or phone call transcripts, data histories, or dictionaries to the coordinator. The information may be provided to subsequent sub-tasks 562 to use, such as a summarization sub-task, or may be accumulated to use to generate a response to the user who initially submitted the expression 502. If certain sub-tasks depend on the completion of prior sub-tasks, the coordinator 560 can determine whether a further sub-task is ready to be performed based on a completion status of one or more other sub-tasks. For example, in this example, a summary of the conversations needs the underlying conversations to be obtained first. Once any necessary prior sub-tasks have been completed, the coordinator 560 can then invoke a first agent to execute the further sub-task. Thus, after the coordinator 560 has caused execution of sub-tasks to obtain the various conversation information, such as by invoking services 580 associated with one or more chat channels, an email inbox, and a transcript repository, the coordinator can then invoke the invoke a second agent to execute the next sub-task and provide the various conversation information as inputs.

Once all of the sub-tasks 562 have completed, the AI virtual assistant 514 invokes its response generation functionality 570 to generate a response to send to the user who submitted the task. The response 504 may be based on one or more output templates. In this example, the response generation functionality 570 provides one or more prompts to the LLM 516, 542 to generate a suitable response to the user. For example, in the case of providing the summary, the LLM 516, 542 itself may generate the summary. The summary may then represent the final output to provide to the user. However, if the original task was to generate an email to another person, the response generation functionality 570 may provide a draft email body provided from a sub-task along with the email address of the targeted person from a different sub-task. It may then obtain a subject for the email from a third sub-task, which may have generated the subject based on the draft email body. The response generation functionality 570 may then provide one or more prompts to the LLM 516, 542 to generate an email along with the outputs from the sub-tasks and an indication of what each output represents, e.g., the email body, the email address, and the subject line along with a suitable template. The LLM 516, 542 may then generate an email document according to a particular format, which may then be provided to the user as an email file along with a message indicating that the email has been created. Other examples may simply indicate that a requested action has been performed.

After the response 504 has been generated, it is transmitted to the remote client device 440 where it is displayed to the user. For example, the summary may be output to the GUI or it may be delivered in another format, if specified by the user, e.g., as an email. In some cases, a message may be output in the GUI indicating that the output has been generated, such as an email requested by the user. The email may be also included in the message or as a separate message within the GUI.

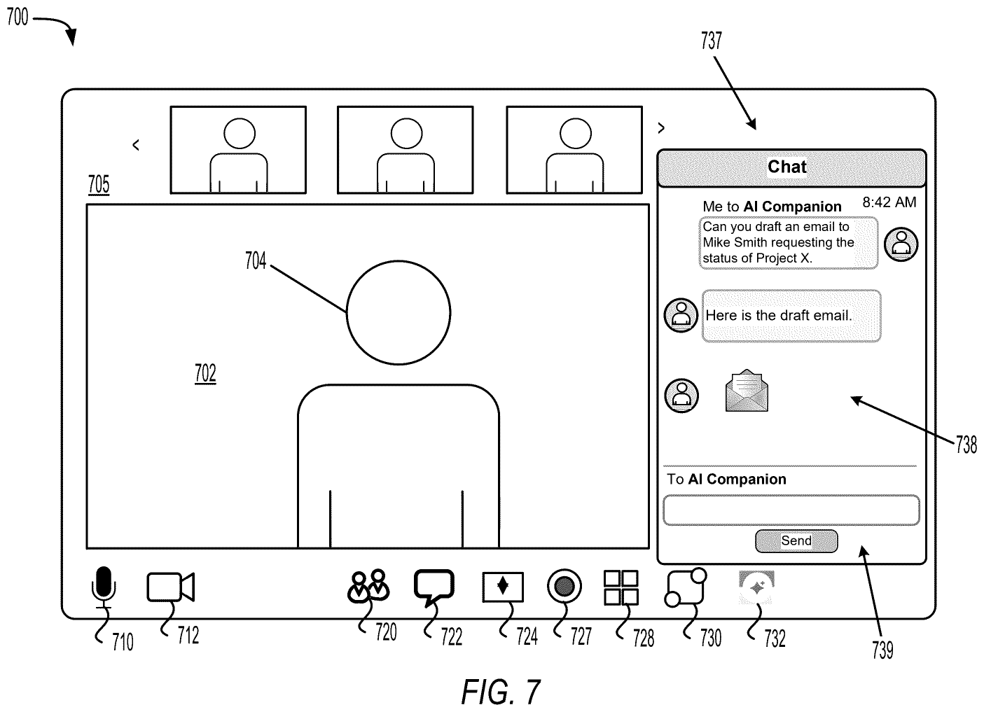

FIG. 6, described above, shows an illustration of such an interaction a user of a client device and the AI virtual assistant using a chat interface. FIG. 7 shows another example of a UI 700 for providing customized, personalized, and extendable LLM-enhanced virtual assistants, according to some aspects of the present disclosure. FIG. 7 depicts an example of a UI 700 that may be shown on a display device of a client device 440 during video conferencing or chat messaging, although the techniques of this disclosure may be implemented in a variety of client UI contexts. In particular, UI 700 depicts an example of the chat interface described in FIG. 6 in the context of a video conference client application or UCaaS client application.

UI 700 shows an in-progress video conference as may be provided by suitable video conference client software. UI 700 includes a main speaker window 702. In some examples, the UI 700 is configured to display the video conference participant 704 that is currently speaking (e.g., “speaker view”) on the main speaker window 702, but other configurations are possible. For instance, some examples include a UI control for “pinning” a particular participant who can be shown in main speaker window 702 regardless of who is speaking.

The UI 700 includes a number of video conference participants 705. In the UI 700 configuration depicted, the participants 705 are shown at the top of the UI 700. Depending on the configuration, in various examples, the participants 705 may be arrayed in a grid-like fashion, may not be shown at all, or may be displayed in some other manner. In this example, the participants 705 are shown above the main speaker window 702 as smaller participant windows, which allow the participant to view some of the other participants in the video conference, as well as controls (“<” and “>”) to let the host scroll to view other participants in the video conference.

The UI 700 includes a number of controls for configuring the video conference or interacting with the participants 705. For example, the UI 700 includes controls 710 and 712 allow a participant to toggle on or off audio or video streams captured by a microphone or camera connected to the client device 440. Control 720 allows the participant to view any other participants present in the video conference along with the participant. Control 722 allows the participant to execute an application or client software function to send text or chat messages to other participants, whether to specific participants or to the entire meeting. Control 724 allows the participant to share content from their client device. Control 727 allows the participant toggle recording of the meeting, and control 728 allows the participant to select an option to join a breakout room. Control 730 allows the participant to launch an app within the video conference client software, to, for example, access content to share with other participants in the video conference.

The control 722, when selected, can launch a chat application 737. The chat application 737 is substantially similar to the GUI 600 described above with respect to FIG. 6. The responses generated by the virtual assistant may include the context created during the in-progress video conference such as video or audio recordings, shared content, partial transcripts generated in real-time as the video conference proceeds, and so on.

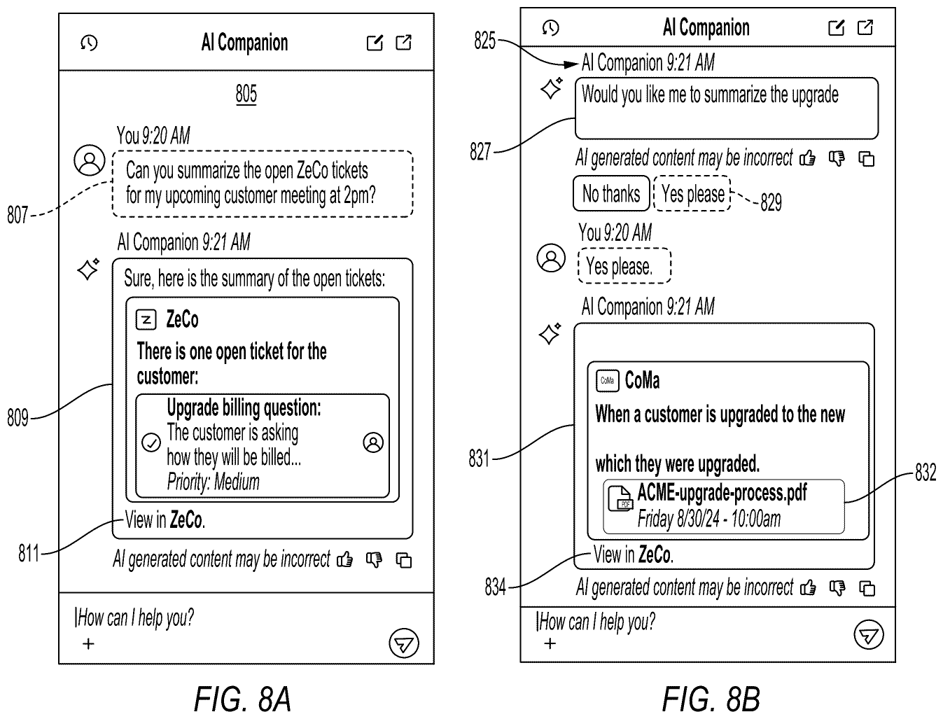

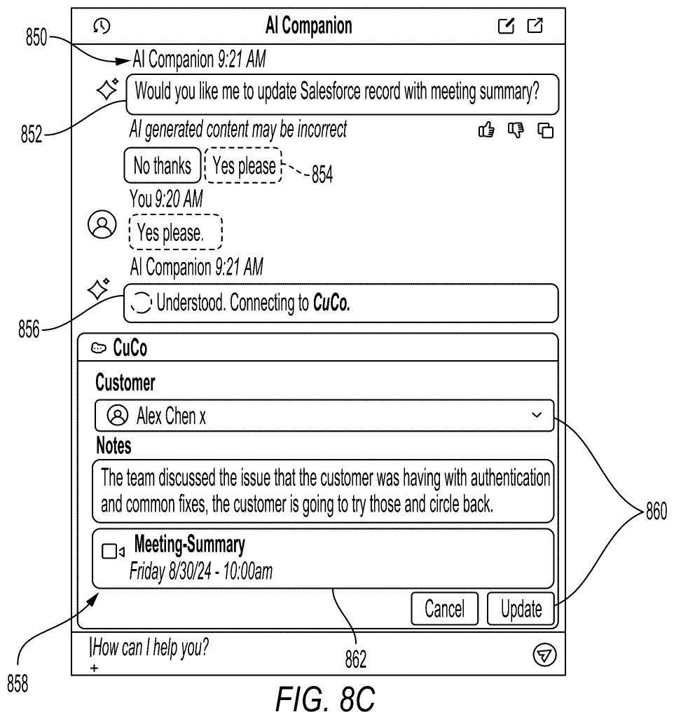

FIGS. 8A-8C show example GUIs involving first-or third-party services for customized, personalized, and extendable LLM-enhanced virtual assistants, according to some aspects of the present disclosure. The GUIs in FIGS. 8A-8C are depicted as chat-like user interfaces, similar to the examples shown in FIGS. 6 and 7 above. However, other user interfaces can be used according to various examples, such as voice-controlled interfaces, augmented or virtual reality interfaces, or asynchronous messaging or email interfaces. These examples may be included among the services 580 described above with respect to FIG. 5.

In FIG. 8A, GUI 805 shows expression 807 requesting a summarization of open tickets related to an upcoming meeting. In this examples, one of the services may include an issue management platform. Issue management platforms may include systems for tracking, prioritizing, and resolving tasks or problems, examples of which include Jira (Atlassian), GitHub Issues (Microsoft), ServiceNow (ServiceNow), or ZenDesk (ZenDesk).

The issue management platform may be included among the available services 580 described in FIG. 5 and indexed in the data store 518. The expression 807 can be used to generate sub-tasks by the LLM 516, 542 for execution by the coordinator 560 or agents 555 to, for example, generate a query in the expression language of the issue management platform API, to execute the query using the API, and to process the response and prepare it for output.

At 809, the virtual assistant replies with a summary of open tickets. The information in response 809 may be obtained using an API provided by the issue management platform that enables queries (e.g., using a custom expression language) for the tickets related to the expression 807. The response 809 also includes formatting and branding that may be provided by the response from the issue management service API to give the virtual assistant output a look and feel consistent with the first- or third-party service. The response 808 also includes a link 811 to the first- or third-party service that can be used to navigate to the first- or third-party service using, for example, a web browser to obtain additional information about the ticket information included in the response 809.

In FIG. 8B, GUI 825 shows an example of expression 827 generated by the virtual assistant. In this example, the virtual assistant may receive the content of a digital communication (e.g., an ongoing video conference or chat conversation, not shown) and propose expressions such as suggested tasks or actions in response. UI control 829 is provided to enable the user to accept to reject the virtual assistant's suggested expression 827. In this example, the virtual assistant suggests a summarization action based on content included in a content management system (“CMS”). CMSs may include systems for creating, editing, organizing, storing, and publishing digital content, examples of which include WordPress (Automattic), Contentful (Contentful), Drupal (Drupal Association), Adobe Experience Manager (Adobe), or Box (Box) for file-based content collaboration and management.

At 831, the virtual assistant replies with a summary derived from information from a CMS associated with the available services 580. The response 831 includes summarized content, a link 832 to content used to derive the summary, and a link 834 to a relevant resource from at the CMS, that can be used to navigate to the first-or third-party service using, for example, a web browser to obtain additional information about the summary included in the response 831.

In FIG. 8C, GUI 850 shows another example of a suggested expression 852. In this example, the virtual assistant is suggesting an update to a persisted record based on the content of a completed digital communication (e.g., a video conference or chat conversation). UI control 854 is provided to enable the user to accept to reject the virtual assistant's suggested expression 852.

At 856, the virtual assistant informs the user that processing of the expression 852 is in progress. In general, this illustrates that the virtual assistant can engage in natural language conversation to mimic the subjective experience of talking with another person. Other examples include responding with acknowledgments like “Got it” or “Let me check on that,” or asking clarifying questions such as “Did you mean the meeting that just ended or the last week's meeting?”

At 858, the response from the first-or third-party service is shown. In this example, the third-party service is Salesforce (Salesforce), a customer relationship management (“CRM”) platform configured among the services 580. CRMs may include systems for managing customer interactions, sales pipelines, and business relationships, etc., examples of which include Salesforce, HubSpot CRM (HubSpot), Zoho CRM (Zoho), or Microsoft Dynamics 365 (Microsoft).

In this example, the response 858 includes a widget provided by the third-party service and rendered by the virtual assistant (e.g., rendering HTML and JavaScript program code provided by the CRM). The widget in the response 858 includes UI controls 860 enabling the user to make updates to a record maintained by the third-party service as well as content populated by the virtual assistant that can be edited by the user. The response 858 also includes a link 862 to a relevant resource from at the CRM related to the record update.

The example first-and third-party services shown in FIGS. 8A-8C are merely examples and should not be construed as limiting with respect to the kinds and varieties of services that can be configured as services 580 for providing customized, personalized, and extendable LLM-enhanced virtual assistants. In general, any service that exposes a suitable API or other integration technique can be configured as a service 580. For example, other integration techniques may include webhooks, database connectors, message queues, direct file system access, and so on. In some examples, a virtual assistant customization application may be provided for configuring such services, sometimes referred to as “skills.”

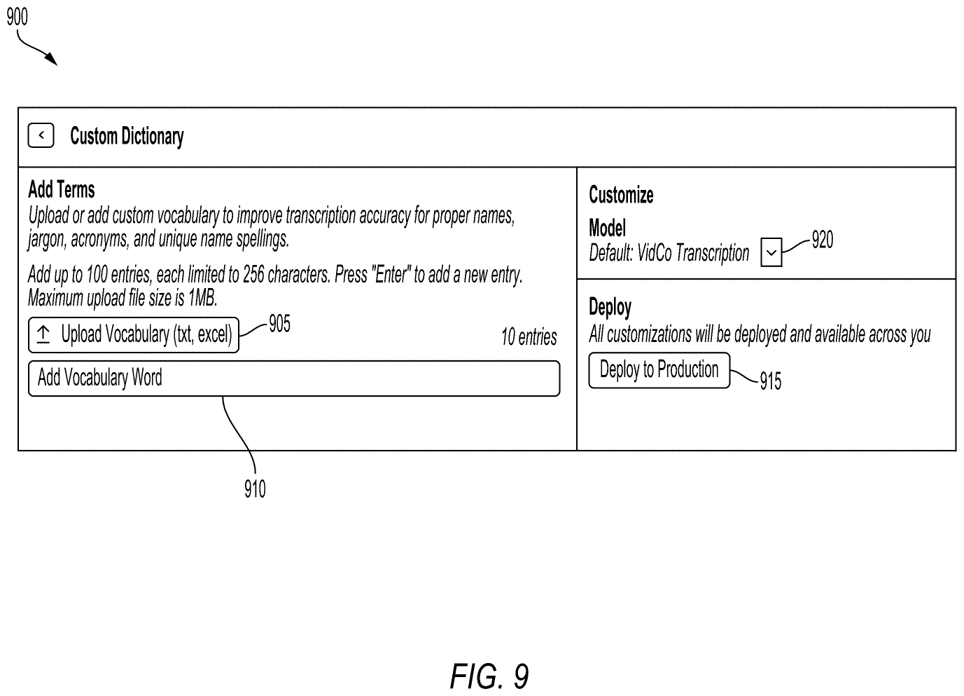

FIG. 9 shows an example GUI 900 for configuring a custom dictionary for customized, personalized, and extendable LLM-enhanced virtual assistants, according to some aspects of the present disclosure. In some examples, custom dictionaries may include lists of words or expressions. Custom dictionaries may also include words or multi-word expressions and their associated contexts, such as mapping to domain-specific meanings, usage constraints, or usage examples. The GUI 900 can be used to instantiate custom dictionaries, add or edit words or expressions, or to add additional context, among other functionality. The information configured using GUI 900 can be persisted in the data store 518 and included in the contextual information provided to virtual assistant (e.g., an LLM used in the agentic framework as illustrated in FIG. 5).

GUI 900 includes UI controls for adding words to a custom dictionary. Upload button 905 can be used to upload words or expressions from a file or network location. For example, a text file, spreadsheet, comma-separated values (“CSV”) file, or other suitable format may be used to list words or expressions, as well as associated context such as definitions, usage, or meanings. Similarly, input box 910 can be used to add words or expressions to the custom dictionary. Some examples may include additional UI controls for adding additional context for words added using the input box 910, such as definitions, tags, metadata, descriptions, and so on.

GUI 900 includes a model selection dropdown control 920. The model selection dropdown control 920 can be used to specify components of the virtual assistant, such as particular agents, LLMs, or services for which the custom dictionary will apply. This can be used to specialize and customize certain aspects of the virtual assistant. In this example, a transcription model is selected. This selection can associate the custom dictionary being edited with an LLM, agent, or service used for transcription tasks. The custom dictionary may be accessed and applied by the virtual assistant when a transcription task is requested by a user or established as a sub-task as a portion of a more complex task or request.

Once the additions or changes to the custom dictionary are made, the deploy button 915 can be used to upload or persist the changes. For example, the custom dictionary may be persisted in the data store 518 of FIG. 5 and accessed for particular sub-tasks as needed. Application of the custom dictionary to the contextual information provided to an LLM may involve adding the custom dictionary or a specified portion thereof to the context window of the LLM.

Some examples may include additional UI controls for creating new custom dictionaries. For example, models selected using the model selection dropdown control 920 can have multiple associated custom dictionaries which can be identified using a suitable identifier (e.g., an alphanumeric name). Other UI controls that may be found in some examples of the GUI 900 for creating or editing custom dictionaries include controls for adding content such as audio, video, or image media to associate with word or expressions, tagging or categorization controls, or controls for editing/deleting existing custom dictionary entries.

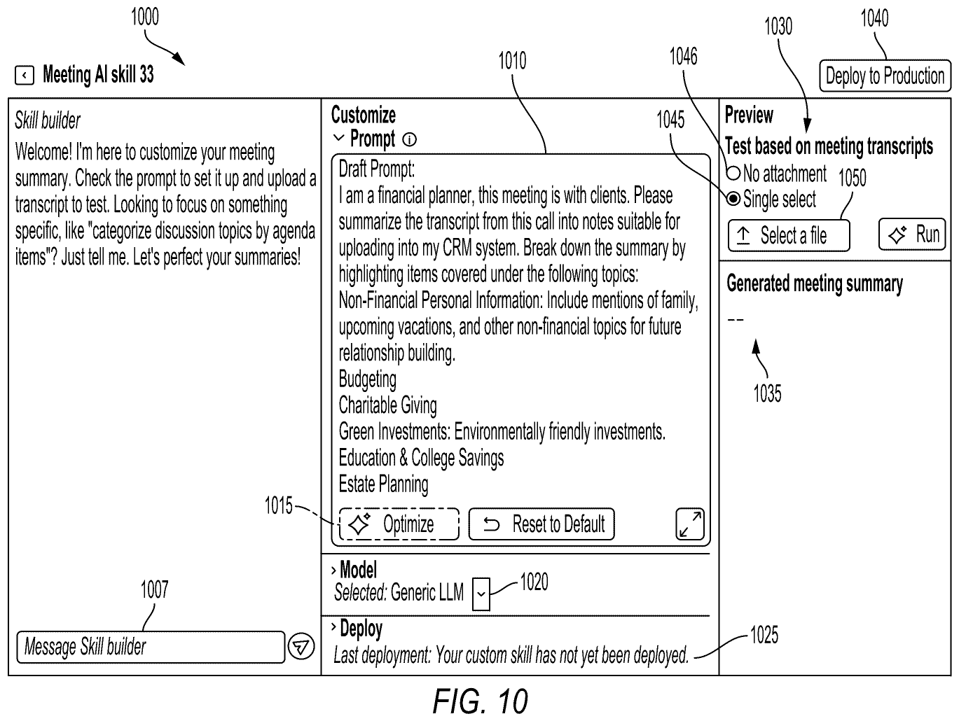

FIG. 10 shows an example GUI 1000 for configuring templates for customized, personalized, and extendable LLM-enhanced virtual assistants, according to some aspects of the present disclosure. In some examples, responding to expressions using a selected template may be referred to as a “skill,” similarly to the services described above. While referring to different functionality (services and templates), the word “skill” may be used to describe both to simplify the user experience. The template editing window 1010 shows a draft template. The example template shown is for a prompt that directs the virtual assistant to generate a summary based on transcript of a phone call or video conference, along with specific instructions about what to include in the summary. The transcript can be added to the template to generate the prompt. For example, the template may include a placeholder such as “{{transcript}}” (not shown) to indicate where the transcript should be added to the template prior to outputting the prompt the virtual assistant. In some examples, the transcript may be appended to the template, for certain categories of templates. For instance, selector 1045 may be selected to indicate that the template requires the appending of a file or other content. Selector 1046 can be selected to indicate that the template does not require any appended content, in which case placeholders populated with specified data can be used.

The GUI 1000 includes optimize button 1015 that can be used to provide the template in template editing window 1010 to an LLM along with a prompt instructing the LLM to edit the draft template to improve grammar, conciseness, clarity, comprehensiveness, and so on. For instance, the prompt may include instructions such as “Improve the grammar and clarity of this template while maintaining its original intent.” Selecting the optimize button 1015 may cause the LLM output to replace the existing draft template.

GUI 1000 includes a model selection dropdown control 1020. The model selection dropdown control 1020 can be used to specify components of the virtual assistant, such as particular agents, LLMs, or services with which the template will apply. This can be used to specialize and customize certain aspects of the virtual assistant. In this example, a generic LLM model is selected. The generic LLM may be, for example, an LLM trained on a general set of knowledge such as public documents on the Internet, for non-specialized tasks. This selection can associate the template being edited with an LLM, agent, or service used for tasks such as summarization, as in this example. The template may be accessed and applied by the virtual assistant when a summarization task is requested by a user or established as a sub-task as a portion of a more complex task or request.

For instance, when a user asks for a summarization, an agent or LLM 516, 542 of the agentic framework, such as the example virtual assistant implementation shown in FIG. 5, may determine a sub-task that includes using a particular model and a particular template based on a review of the templates in the data store 518 associated with the designated model. In the example shown in FIG. 10, the sub-task may involve designating a generic LLM agent for the sub-task and using the template shown in template editing window 1010.

The template being edited in template editing window 1010 can be tested prior to deployment using a test transcript. For example, when selector 1045 is selected, the file upload button 1050 may be shown or enabled. A test transcript can be appended to the template being edited in the template editing window 1010. The resulting prompt consisting of the template with any placeholder variables populated and the test transcript appended, can be output to the model selected using model selection dropdown control 1020. UI controls such as an output window 1035 or an embedded web browser can be used to display the output of the test. In some examples, additional test controls may be included such as values to include in placeholder variables.

Once template editing is completed and tested, the template can be deployed (e.g., to data store 518) using the deploy button 1040. The deployment indicator 1025 may be updated accordingly following deployment to show the timestamp of the most recent deployment, and additional information about the deployment such as the version of the template deployed, changes, associated models, and so on.

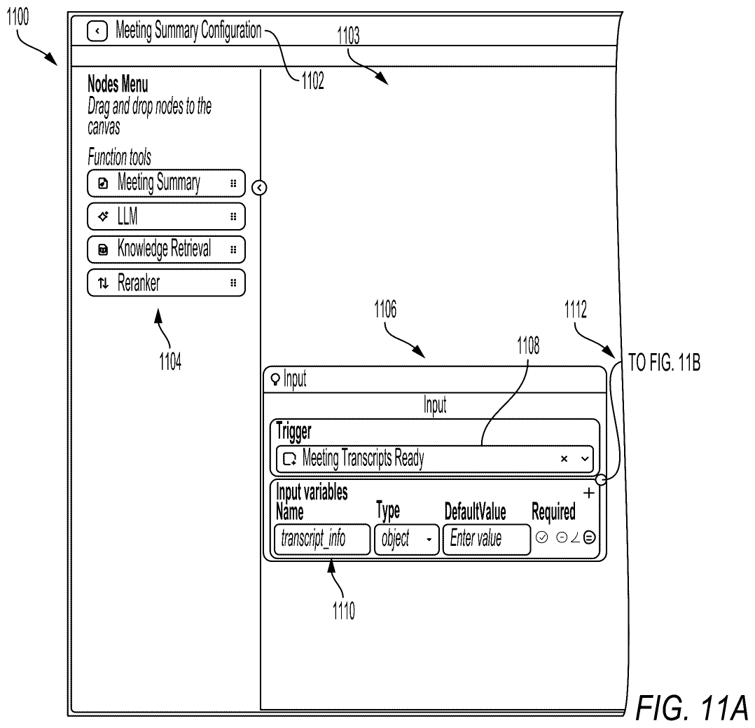

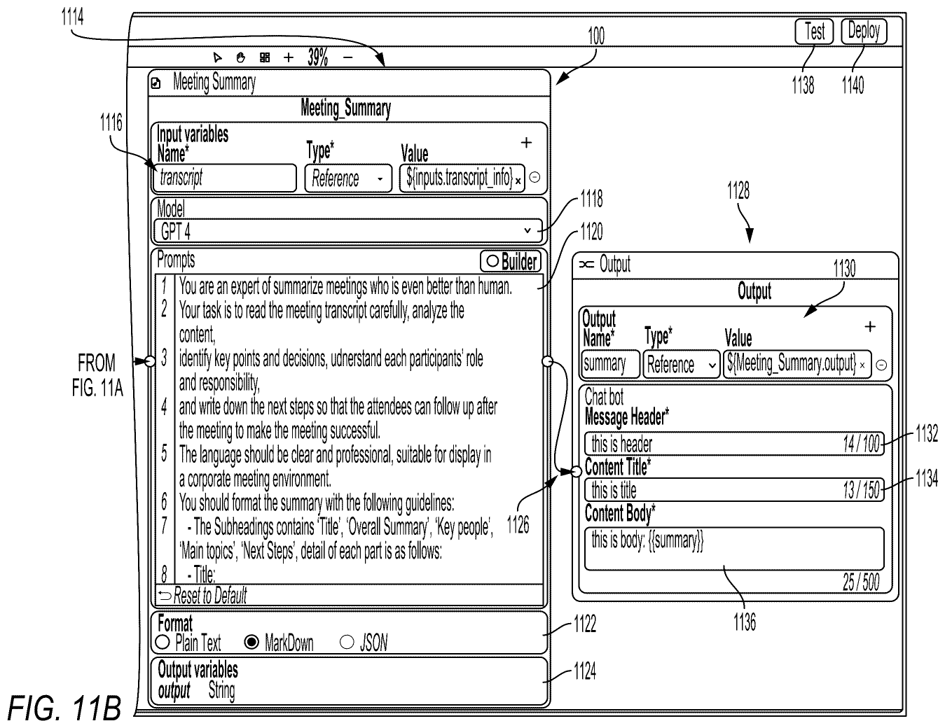

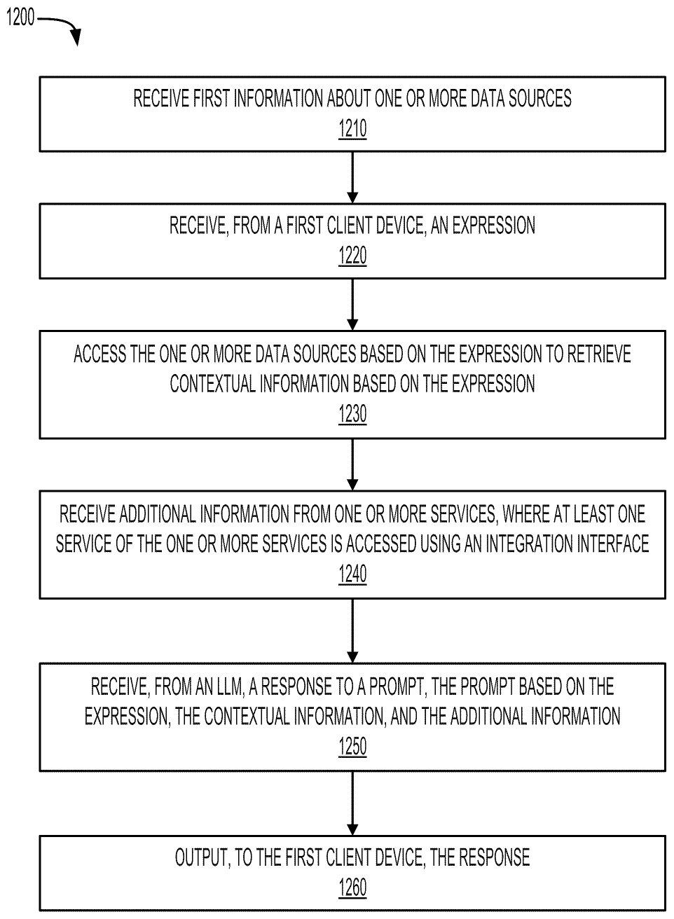

FIGS. 11A-11B show another example GUI 1100 for configuring templates for customized, personalized, and extendable LLM-enhanced virtual assistants, according to some aspects of the present disclosure. This example shows templates for prompting of the virtual assistant (e.g., an LLM) as well as for generating the response. The templates are shown in the context of a graphical workflow designer for customizing virtual assistant actions in response to certain triggers.

GUI 1100 depicts an example workflow for an action involving the virtual assistant automatically generating a meeting summary. The name 1102 of the action is shown at the top of the GUI 1100. The workflow design window 1103 includes a number of draggable nodes corresponding events, actions, data flows, etc. that may be involved with generating a virtual assistant response. At 1104, several example node types 1104 are shown. The example node types 1104 include a meeting summary generation node (shown at 1114), a generic LLM prompting node, a knowledge retrieval node, and a re-ranker node. The knowledge retrieval node can be used for accessing and applying data from one or more data sources (e.g., custom dictionaries or data history) to the prompts or responses. The re-ranker node may include functionality for evaluating and reordering a set of generated candidate LLM outputs based on a scoring technique to improve the alignment of generated outputs with specified objectives. In addition to these examples, many other node types may be used in accordance with the particular application.

In example GUI 1100, an input node 1106 and an output node 1128 are included by default. The input node 1106 includes a trigger selection control 1108. The trigger selection control 1108 can be used to select one or more preconfigured triggers for automation virtual assistant action in response to direct or indirect expressions received from a client device. In this example, “Meeting Transcripts Ready” is selected, which may correspond to an action automatically taken by the virtual assistant when the transcripts asynchronously generated following a video conference are completed.

Input node 1106 also includes input variable controls 1110. The input variable controls 1110 can be used to declare or initialize certain variables that can be used in different nodes for populating placeholders in template, intermediate operations, or other purposes. For example, the input variable controls 1110 can be used to populate variables with values determined at execution time, such as dates, times, information about context (e.g., video conference participants'names), and so on. In some examples, input variables may be hard-coded or predetermined for particular workflows. In the example shown, the configured input variable “transcript_info” may be automatically populated with information about or the content of the completed transcripts. The value of the “transcript_info” variable can then be inserted into a template using a placeholder such as “${transcript_info}”. The input variable controls 1110 can include sub-controls for specifying variable name, type, default values, whether the variable is required or not, and so on.

The output of the input node 1106 is sent to the next example node shown, the meeting summary generation node 1114. The arrow at 1112 represents the flow of data from the input node 1106 to the meeting summary generation node 1114, such as the completed transcripts or configured input variables. The meeting summary generation node 1114 is an example of a node dragged onto the workflow design window 1103 from the node types 1104.

The meeting summary generation node 1114 includes input variables control 1116, similar to the input variable controls 1110 for input node 1106. The input variables configured at input node 1106 can be accessed using the input variables control 1116. In this example, the received data from input node 1106 can be accessed using an “input” object, using a dotted syntax similar to the syntax used in object-oriented programming. Here, the variable “transcript” is declared and initialized using a placeholder, “${input.transcript_info}”. The variable “transcript” is then available for substitution in the template below.

The model selection dropdown control 1118 can be used to select virtual assistant components, such as specific LLMs, agents, or services, to associate the template with. The template editing window 1120 shows a template that will be used to generate a prompt for an LLM or other virtual assistant component. Variables configured using the input variables controls 1116 may be substituted or accessed using suitable placeholder syntax. The format of the template can be specified using the format selector 1122, such as plain text, Markdown, HTML, JSON, etc. Specifying the template format type can be used to enforce the format in the template editing window 1120 as well as to provide features in the template editing window 1120 such as syntax highlighting.

Output variable controls 1124 can be used to configure the output of the LLM or other virtual assistant component after receiving the prompt generated using the template. In this example, the response generated by the LLM is labeled as “output” and typed as a String variable. As with the input variables described above, this data can be accessed by downstream connected nodes using a suitable syntax on a suitable object.

The meeting summary generation node 1114 is connected to the next example node shown, the output node 1128. Output node 1128 can be used to edit a template for displaying the results of the task to the user following the execution of the task using, for example, a chat-like interface. Input variable controls 1130 are again used. The output variable configured at the meeting summary generation node 1114 is accessed using a dotted syntax on the “Meeting_Summary” object and made available through the “summary” variable.

A message header input box 1132 can be used to configure a header that will be sent to the output along with the title and body configured below. The header may include additional information used for properly rendering the output template such as metadata, authentication information, accessibility information, and so on. The content title input box 1134 can be used to configure a title for the response. The title may be shown, for example, above the body in certain output interfaces. The output template editing window 1136 can be used to configure the output template. In this example, the summary generated by the virtual assistant using the template configured at the meeting summary generation node 1114 is inserted at the placeholder “{{summary}}”.

Configured workflows can be tested using test control 1138 and deployed to designated environments using deploy button 1140. Test control 1138 can cause a test UI to be displayed that enables selection of test data, population of variables with specified data, simulation of triggering actions, and so on. The deploy button 1140 may cause a deploy UI to be displayed that allows for selection of a target environment (e.g., production or development environments).

Referring now to FIG. 12, FIG. 12 shows a flowchart of an example method 1200 for providing customized, personalized, and extendable LLM-enhanced virtual assistants, according to some aspects of the present disclosure. The description of the method 1200 in FIG. 12 will be made with reference to FIGS. 4-12, however any suitable system according to this disclosure may be used, such as the example systems 100 and 200, shown in FIGS. 1 and 2. It should be appreciated that method 1200 provides a particular method for providing customized, personalized, and extendable LLM-enhanced virtual assistants. Other sequences of operations may also be performed according to alternative examples. For example, alternative examples of the present disclosure may perform the steps outlined below in a different order. Moreover, the individual operations illustrated by method 1200 may include multiple sub-operations that may be performed in various sequences as appropriate to the individual operation. Furthermore, additional operations may be added or removed depending on the particular applications. Further, the operations described in method 1200 may be performed by different devices. For example, the description is given from the perspective of a component of the virtual conference provider 410 of FIG. 4 such as the AI virtual assistant 414 but other configurations are possible. One of ordinary skill in the art would recognize many variations, modifications, and alternatives.

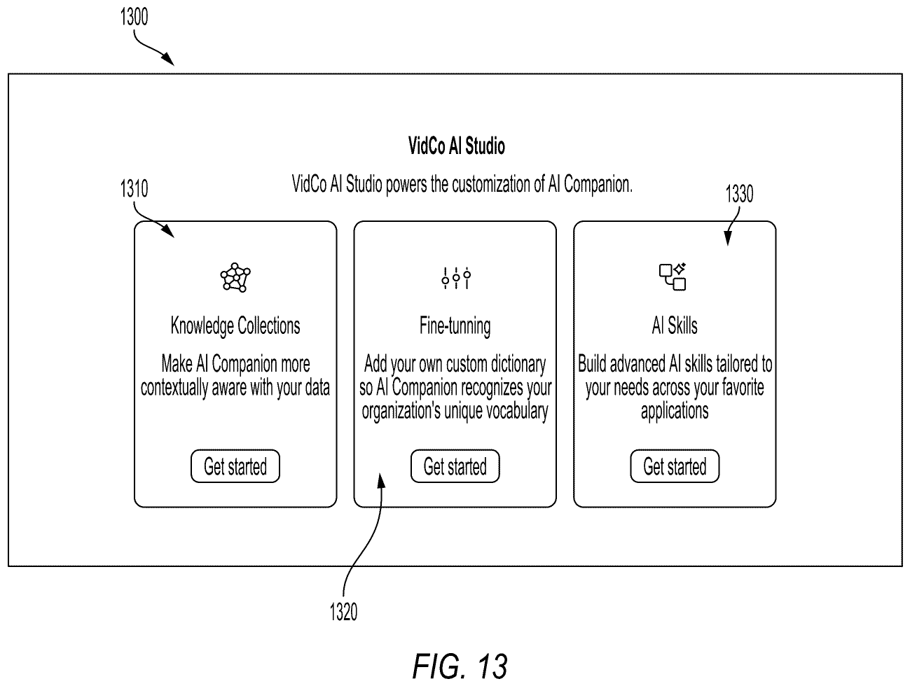

The method 1200 may include block 1210. At block 1210, a computing system such as the AI virtual assistant 414 of FIG. 4 receives first information about one or more data sources. For example, a virtual assistant customization application such as the one shown below in FIG. 13 can be used to add or configure the one or more data sources. The one or more data sources may include, for example, data history, custom dictionaries or glossaries, document stores on local or remote filesystems or network drives, information from the Internet (e.g., Wikipedia, scraped websites, or APIs), databases, media (e.g., video, images, audio, etc.), and so on. An example of a GUI for creating or editing a custom dictionary is shown in FIG. 9 above. The one or more data sources can be included in the contextual information provided to the virtual assistant to respond to queries or instructions.

In some examples, the first information may also include a template. The template may be used to construct prompts for the virtual assistant (and LLMs used therein) tailored for specific purposes. For example, a template may be associated with specific capabilities of the virtual assistant and can be used to prompt LLMs and other agents to perform tasks and sub-tasks. Examples of GUIs for editing templates are shown above in FIGS. 10 and 11.

At block 1220, the computing system receives, from a first client device, an expression. The expression may be directly input to the computing system using a chat-like interface (e.g., the interface shown in FIGS. 6 and 7). For instance, a user of the first client device may use the expression to direct the virtual assistant to perform a certain task or answer a certain query. For instance, the first participant may instruction the virtual assistant as, “AI Companion, please generate a summary of this meeting so far and email it to my supervisor.” In some examples, the expression may be detected in the transcript (or determined using the audio directly) by the virtual assistant, which may serve as an indirect instruction or query. For example, the first client device may be a participant in video conference, among a number of participants, hosted by the video conference provider. The video conference may be continuously transcribed in real-time or near-real-time (provided each participant has explicitly consented to the transcription). In this example, the expression can be based on a spoken utterance by a first participant using the first client device.

In some examples, the first client device may be joined to a video conference provided by an external video conference provider. For example, while the video conference provider (e.g., virtual conference provider 410 of FIG. 4) may be used to host video conferences, external video conference providers operated by third parties can be used as well. The video conference provider can provide integrations with the external video conference provider client software that can relay information about participants, digital communications, metadata, etc. back to the video conference provider. Expressions can be received based on digital communications that are performed using external video conference provider client software. The virtual assistant can generate responses based on the expressions received from the external video conference providers and output a message to the external video conference provider including the response to cause the message to be received by the first client device, via the integration.

For example, Zoom Communications, Inc. may operate the video conference provider while external video conference providers such as Microsoft Teams or Google Meet may provide third party integrations that exchange information with Zoom's video conference provider. This can enable the virtual assistant to receive expressions generated using Teams or Meet client software and generate responses that will be displayed in the GUIs of the Teams or Meet client software.

At block 1230, the computing system accesses the one or more data sources based on the expression to retrieve contextual information based on the expression. For example, the one or more data sources can be accessed via the data store 518 of FIG. 5.

In some examples, the contextual information is text generated based on the one or more data sources that can be added to an LLM prompt. Contextual information can be generated using the one or more data sources using various methods. For examples, the one or more data sources may include a document store or knowledge base. Retrieval augmented generation (“RAG”) can be used to select relevant documents and add them (or a portion thereof) to the contextual information. Other examples of methods for generating contextual information from the one or more data sources include querying relational databases and converting the output to natural language, converting structured data to natural language, or adding a data source to the contextual information as-is. For instance, if the data source is a custom dictionary, it may be included in its entirety to ensure the customized vocabulary is used in the response.

At block 1240, the computing system receives additional information from one or more services, where at least one service of the one or more services is accessed using an API. For example, the one or more services may include pre-configured first-or third-party APIs, databases, web services or sites, streaming data platforms, messaging queues, and so on. Examples of first-or third-party services that may be configured are shown above in FIGS. 8A-8C.

As described in FIGS. 4 and 5, the virtual assistant can be based on agentic framework configured to determine a number of sub-tasks to address the query or task included in the expression. Among these sub-tasks may be instructions to access the at least one service to obtain additional information or to accomplish certain tasks. A virtual assistant component such as the coordinator 560 can maintain an index of the available agents and services, including a description of the available functionality, authentication and authorization information, instructions for querying or operating the services, and so on.

For example, a third-party issue management application such as JIRA (Atlassian) may be configured as a service. An expression such as “Let's talk about the ticket you're working on.” by a first chat participant to a second chat participant can cause the creation of a first sub-task to query the issue management system for “in progress” tickets for the second participant and second sub-task to generate a response asking the chat participants if they would like to see a summary of the second participant's in progress tasks.

At block 1250, the computing system receives, from an LLM, a response to a prompt, the prompt based on the expression, the contextual information, and the additional information. For example, the coordinator 560 of FIG. 5 can marshal the results of several sub-tasks 562 involving obtaining contextual information from the one or more data sources, additional information from the at least one service, and, in some examples, a template, to generate a prompt for the LLM 516, 542. For example, the prompt can be output to the LLM 516, 542 which will result in generation of a response in accordance with the template, which may, for example, specify an output format.

At block 1260, the computing system outputs, to the first client device, the response. The response may be formatted or marked up to display in a format that will integrate with a functionality of the first client device. For example, if the expression was received from a chat-like interface, then the response may be formatted to appear as a response from a chat participant, such as the examples shown in FIGS. 6 and 7. In another example, if the expression is received indirectly (e.g., based on an automatically generated transcript such as the example shown in FIGS. 11A-11B), then the response may be formatted to be displayed in a UI control of a video conference application, such as a pop-up dialog window.

In some examples, for a digital communication session involving a number of client devices engaged in conversation (e.g., during a video conference or chat conversation), the computing system may receive additional expressions that are a portion of the conversation. For example, the additional expressions may be portions of a transcript of a video conference or chat thread. The virtual assistant can then participate in the conversation. For example, the additional expressions can be provided to an LLM backing the virtual assistant, along with suitable contextual information from the one or more data sources, the additional information from the one or services, and any applicable templates. The virtual assistant can then output, to the respective client devices, the contribution to the conversation.

For example, in an chat conversation, participant Alice may write “Hi, Bob, I was thinking about the project yesterday.” Participant Bob may reply, “What did you conclude?” The virtual assistant, given the chat conversation to this point, data sources such as user data histories, services such as CRMs or issue trackers, and applicable templates, may include these additional expressions written by Alice and Bob in a prompt to an LLM and add to the conversation, “Alice and Bob, I see that you are talking about the project. Would you like me to display a summary of recent updates?”

In one example application, the virtual assistant can be used as a personal coaching application. After the response is returned to the client device, additional expressions responsive to the response may be received by the virtual assistant. The LLM 516, 542 can be prompted to generate coaching information in response to certain prompt based on the additional expressions, the contextual information, the additional information, and, in some examples, a template. The prompt may be based on a template generated using GUIs such as the examples shown in FIGS. 10 and 11. Using the virtual assistant for personal coaching can involve data sources such as user interactions (e.g., transcripts, audio data, chat messages, email, etc.) to identify behavioral patterns. The identified patterns can be used to generate suggestions or recommendations relating to task, time management or scheduling, and workflow or efficiency improvements, and so on.

The personal coaching application can, for example, track personal goals configured using a suitable GUI. The personal goals can be selected from predefined personal goals or created using custom prompts. For example, an inclusivity goal for a customer support representative may be defined that includes configurations to determine a number of interruptions, a number of non-inclusive terms used, and a talk-listen ratio during a period of time, such as for a particular video conference or conferences. Each of the measured parameters can be determined using a custom prompt, predefined variables, scripting (e.g., JavaScript), and so on, using a no-code or low-code interface. The virtual assistant configuration application can be used to configure a custom knowledge base relating to inclusivity (e.g., a particular lexicon), prompt and response templates, or first- and third-party extensions. For instance, the virtual assistant configuration application can be configured to assess inclusivity during video conferences by adding a custom knowledge base including non-inclusive terms, prompt and response templates to measure the number of interruptions given a transcript of the video conference, and scripting capabilities to calculate the talk-listen ratio, again given a transcript of the video conference.

FIG. 13 shows example of a GUI 1300 for a virtual assistant customization application for configuring customized, personalized, and extendable LLM-enhanced virtual assistants, according to some aspects of the present disclosure. In this example, the virtual assistant customization application, called an “AI Studio” in this example can be used for accessing various aspects of configuration functionality. Three examples are shown in GUI 1300.

The knowledge collections functionality 1310 can be used for adding or editing data sources such as user data history, documents, media (e.g., images, audio, or video), and so on. The knowledge collections functionality 1310 may further include components for specifying a time bound for the participant data history as well as identifying other data sources. The fine-tuning functionality 1320 can be used for configuring data sources such as custom domain- or organization-specific dictionaries or glossaries. The AI skills functionality 1330 can be used for adding or configuring first-or third-party integrations with the services available to the virtual assistant (e.g., services 580 in FIG. 5). In this example, “skills” can refer generally to additional functionality enabled for the virtual assistant using a first- or third-party application. Other functionality in addition to these examples can be included with the virtual assistant customization application according to various examples.

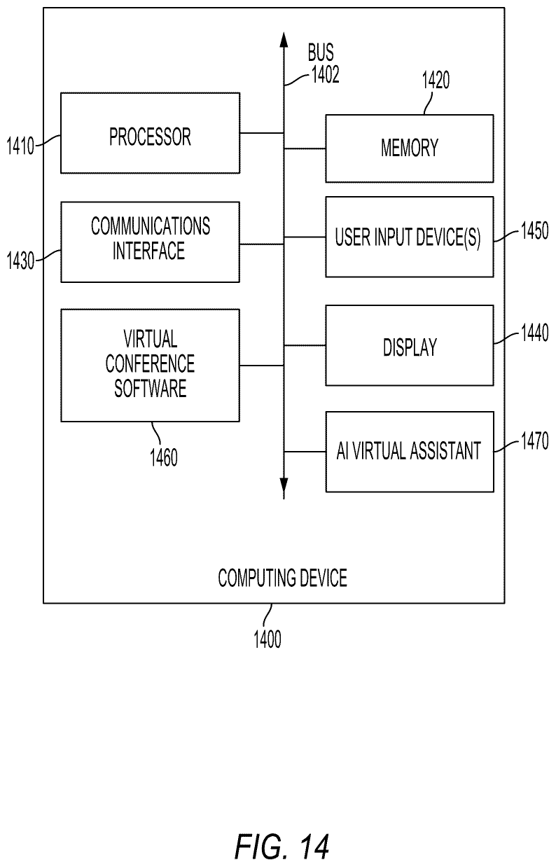

Referring now to FIG. 14, FIG. 14 shows an example computing device 1400 suitable for use in example systems or methods for providing customized, personalized, and extendable LLM-enhanced virtual assistants, according to some examples of the present disclosure. The example computing device 1400 includes a processor 1410 which is in communication with the memory 1420 and other components of the computing device 1400 using one or more communications buses 1402, including the AI virtual assistant 1470. The AI virtual assistant 1470 may be similar to the AI virtual assistant 414 or 514 as described above. The processor 1410 is configured to execute processor-executable instructions stored in the memory 1420 to perform one or more methods for providing customized, personalized, and extendable LLM-enhanced virtual assistants according to different examples, such as part or all of the example method 1200 described above with respect to FIG. 12. The computing device 1400, in this example, also includes one or more user input devices 1450, such as a keyboard, mouse, touchscreen, microphone, etc., to accept user input. The computing device 1400 also includes a display 1440 to provide visual output to a user.

In addition, the computing device 1400 includes virtual conferencing software 1460 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 1400 also includes a communications interface 1430. In some examples, the communications interface 1430 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a method, comprising: receiving first information about one or more data sources; receiving, from a first client device, an expression; accessing the one or more data sources based on the expression to retrieve contextual information based on the expression; receiving additional information from one or more services, where at least one service of the one or more services is accessed using an integration interface; receiving, from a large language model (“LLM”), a response to a prompt, the prompt based on the expression, the contextual information, and the additional information; and outputting, to the first client device, the response.

Example 2 is the method of example(s) 1, wherein the one or more data sources includes second information about a data history of a user of the first client device.

Example 3 is the method of example(s) 1, wherein the one or more data sources includes a dictionary comprising a plurality of expressions and associated contexts.

Example 4 is the method of example(s) 1, where the one or more services include an issue management platform.

Example 5 is the method of example(s) 1, wherein: the method further comprises: joining the first client device to a video conference, the video conference being joined by a plurality of client devices including the first client device; and the expression is based on a spoken utterance by a first participant using the first client device.

Example 6 is the method of example(s) 5, further comprising: receiving, from a subset of the plurality of client devices, additional expressions, the additional expressions being a portion of a conversation among a plurality of participants using the respective subset of the plurality of client devices, including the first participant; receiving, from the LLM, a contribution to the conversation in response to a second prompt, the second prompt based on the additional expressions, the contextual information, and the additional information; and outputting, to the first client device, the contribution to the conversation.

Example 7 is the method of example(s) 1, further comprising: receiving, from the first client device, additional expressions responsive to the response; receiving, from the LLM, coaching information in response to a second prompt, the second prompt based on the additional expressions, the contextual information, and the additional information; and outputting, to the first client device, the coaching information.

Example 8 is the method of example(s) 1, wherein: the method further comprises: receiving a first indication that the first client device is joined to a video conference provided by an external video conference provider, the video conference being joined by a plurality of client devices including the first client device; and receiving the expression comprises receiving a second indication of the expression from the external video conference provider; and outputting the response comprises outputting a message to the external video conference provider including the response to cause the message to be received by the first client device.

Example 9 is the method of example(s) 1, wherein: the LLM is a component of an agentic framework including one or more agents configured to perform one or more respective specialized tasks, wherein the agentic framework comprises a coordination mechanism that manages interactions between the one or more agents based on the expression; and the response is generated by the agentic framework using the expression, the contextual information, and the additional information by: determining an intent associated with the response; selecting at least one agent of the one or more agents based on the intent and the contextual information; instructing the selected agents to execute tasks to retrieve or generate additional content; and generating the response using the additional content.

Example 10 is the method of example(s) 1, wherein: the first information further includes a template; and the prompt is further based on the template.

Example 11 is a non-transitory computer-readable storage medium storing processor-executable instructions configured to cause one or more processors to: receive first information about one or more data sources; receive, from a first client device, an expression; access the one or more data sources based on the expression to retrieve contextual information based on the expression; receive additional information from one or more services, where at least one service of the one or more services is accessed using an integration interface; receive, from an LLM, a response to a prompt, the prompt based on the expression, the contextual information, and the additional information; and output, to the first client device, the response.

Example 12 is the non-transitory computer-readable storage medium of example(s) 11, wherein the one or more data sources includes a dictionary comprising a plurality of expressions and associated contexts.

Example 13 is the non-transitory computer-readable storage medium of example(s) 11, wherein: the processor-executable instructions are further configured to cause the one or more processors to: join the first client device to a video conference, the video conference being joined by a plurality of client devices including the first client device; and the expression is based on a spoken utterance by a first participant using the first client device.

Example 14 is the non-transitory computer-readable storage medium of example(s) 11, wherein the processor-executable instructions are further configured to cause the one or more processors to: receive, from the first client device, additional expressions responsive to the response; receive, from the LLM, coaching information in response to a second prompt, the second prompt based on the additional expressions, the contextual information, and the additional information; and output, to the first client device, the coaching information.

Example 15 is the non-transitory computer-readable storage medium of example(s) 11, wherein: the LLM is a component of an agentic framework including one or more agents configured to perform one or more respective specialized tasks, wherein the agentic framework comprises a coordination mechanism that manages interactions between the one or more agents based on the expression; and the response is generated by the agentic framework using the expression, the contextual information, and the additional information by: determining an intent associated with the response; selecting at least one agent of the one or more agents based on the intent and the contextual information; instructing the selected agents to execute tasks to retrieve or generate additional content; and generating the response using the additional content.

Example 16 is a system comprising: one or more non-transitory computer-readable media; and one or more processors communicatively coupled to the one or more non-transitory computer-readable media, the one or more processors configured to execute processor-executable instructions stored in the non-transitory computer-readable media to: receive first information about one or more data sources; receive, from a first client device, an expression; access the one or more data sources based on the expression to retrieve contextual information based on the expression; receive additional information from one or more services, where at least one service of the one or more services is accessed using an integration interface; receive, from an LLM, a response to a prompt, the prompt based on the expression, the contextual information, and the additional information; and output, to the first client device, the response.

Example 17 is the system of example(s) 16, wherein the one or more data sources includes a dictionary comprising a plurality of expressions and associated contexts.

Example 18 is the system of example(s) 16, wherein: the one or more processors are further configured to execute processor-executable instructions stored in the non-transitory computer-readable media to: join the first client device to a video conference, the video conference being joined by a plurality of client devices including the first client device; and the expression is based on a spoken utterance by a first participant using the first client device.

Example 19 is the system of example(s) 16, wherein: the one or more processors are further configured to execute processor-executable instructions stored in the non-transitory computer-readable media to: receive a first indication that the first client device is joined to a video conference provided by an external video conference provider, the video conference being joined by a plurality of client devices including the first client device; and receive the expression comprises receiving a second indication of the expression from the external video conference provider; and outputting the response comprises outputting a message to the external video conference provider including the response to cause the message to be received by the first client device.

Example 20 is the system of example(s) 16, wherein: the LLM is a component of an agentic framework including one or more agents configured to perform one or more respective specialized tasks, wherein the agentic framework comprises a coordination mechanism that manages interactions between the one or more agents based on the expression; and the response is generated by the agentic framework using the expression, the contextual information, and the additional information by: determining an intent associated with the response; selecting at least one agent of the one or more agents based on the intent and the contextual information; instructing the selected agents to execute tasks to retrieve or generate additional content; and generating the response using the additional content.

What is claimed is:

1. A method, comprising:
receiving first information about one or more data sources;
receiving, from a first client device, an expression;
accessing the one or more data sources based on the expression to retrieve contextual information based on the expression;
receiving additional information from one or more services, where at least one service of the one or more services is accessed using an integration interface;
receiving, from a large language model (“LLM”), a response to a prompt, the prompt based on the expression, the contextual information, and the additional information; and
outputting, to the first client device, the response.

2. The method of claim 1, wherein the one or more data sources includes second information about a data history of a user of the first client device.

3. The method of claim 1, wherein the one or more data sources includes a dictionary comprising a plurality of expressions and associated contexts.

4. The method of claim 1, where the one or more services include an issue management platform.

5. The method of claim 1, wherein:
the method further comprises:
joining the first client device to a video conference, the video conference being joined by a plurality of client devices including the first client device; and
the expression is based on a spoken utterance by a first participant using the first client device.

6. The method of claim 5, further comprising:
receiving, from a subset of the plurality of client devices, additional expressions, the additional expressions being a portion of a conversation among a plurality of participants using the respective subset of the plurality of client devices, including the first participant;
receiving, from the LLM, a contribution to the conversation in response to a second prompt, the second prompt based on the additional expressions, the contextual information, and the additional information; and
outputting, to the first client device, the contribution to the conversation.

7. The method of claim 1, further comprising:
receiving, from the first client device, additional expressions responsive to the response;
receiving, from the LLM, coaching information in response to a second prompt, the second prompt based on the additional expressions, the contextual information, and the additional information; and
outputting, to the first client device, the coaching information.

8. The method of claim 1, wherein:
the method further comprises:
receiving a first indication that the first client device is joined to a video conference provided by an external video conference provider, the video conference being joined by a plurality of client devices including the first client device; and
receiving the expression comprises receiving a second indication of the expression from the external video conference provider; and
outputting the response comprises outputting a message to the external video conference provider including the response to cause the message to be received by the first client device.

9. The method of claim 1, wherein:
the LLM is a component of an agentic framework including one or more agents configured to perform one or more respective specialized tasks, wherein the agentic framework comprises a coordination mechanism that manages interactions between the one or more agents based on the expression; and
the response is generated by the agentic framework using the expression, the contextual information, and the additional information by:
determining an intent associated with the response;
selecting at least one agent of the one or more agents based on the intent and the contextual information;
instructing the selected agents to execute tasks to retrieve or generate additional content; and
generating the response using the additional content.

10. The method of claim 1, wherein:
the first information further includes a template; and
the prompt is further based on the template.

11. A non-transitory computer-readable storage medium storing processor-executable instructions configured to cause one or more processors to:
receive first information about one or more data sources;
receive, from a first client device, an expression;
access the one or more data sources based on the expression to retrieve contextual information based on the expression;
receive additional information from one or more services, where at least one service of the one or more services is accessed using an integration interface;
receive, from an LLM, a response to a prompt, the prompt based on the expression, the contextual information, and the additional information; and
output, to the first client device, the response.

12. The non-transitory computer-readable storage medium of claim 11, wherein the one or more data sources includes a dictionary comprising a plurality of expressions and associated contexts.

13. The non-transitory computer-readable storage medium of claim 11, wherein:
the processor-executable instructions are further configured to cause the one or more processors to:
join the first client device to a video conference, the video conference being joined by a plurality of client devices including the first client device; and
the expression is based on a spoken utterance by a first participant using the first client device.

14. The non-transitory computer-readable storage medium of claim 11, wherein the processor-executable instructions are further configured to cause the one or more processors to:
receive, from the first client device, additional expressions responsive to the response;
receive, from the LLM, coaching information in response to a second prompt, the second prompt based on the additional expressions, the contextual information, and the additional information; and
output, to the first client device, the coaching information.

15. The non-transitory computer-readable storage medium of claim 11, wherein:
the LLM is a component of an agentic framework including one or more agents configured to perform one or more respective specialized tasks, wherein the agentic framework comprises a coordination mechanism that manages interactions between the one or more agents based on the expression; and
the response is generated by the agentic framework using the expression, the contextual information, and the additional information by:
determining an intent associated with the response;
selecting at least one agent of the one or more agents based on the intent and the contextual information;
instructing the selected agents to execute tasks to retrieve or generate additional content; and
generating the response using the additional content.

16. A system comprising:
one or more non-transitory computer-readable media; and
one or more processors communicatively coupled to the one or more non-transitory computer-readable media, the one or more processors configured to execute processor-executable instructions stored in the non-transitory computer-readable media to:
receive first information about one or more data sources;
receive, from a first client device, an expression;
access the one or more data sources based on the expression to retrieve contextual information based on the expression;
receive additional information from one or more services, where at least one service of the one or more services is accessed using an integration interface;
receive, from an LLM, a response to a prompt, the prompt based on the expression, the contextual information, and the additional information; and
output, to the first client device, the response.

17. The system of claim 16, wherein the one or more data sources includes a dictionary comprising a plurality of expressions and associated contexts.

18. The system of claim 16, wherein:
the one or more processors are further configured to execute processor-executable instructions stored in the non-transitory computer-readable media to:
join the first client device to a video conference, the video conference being joined by a plurality of client devices including the first client device; and
the expression is based on a spoken utterance by a first participant using the first client device.

19. The system of claim 16, wherein:
the one or more processors are further configured to execute processor-executable instructions stored in the non-transitory computer-readable media to:
receive a first indication that the first client device is joined to a video conference provided by an external video conference provider, the video conference being joined by a plurality of client devices including the first client device; and
receive the expression comprises receiving a second indication of the expression from the external video conference provider; and
outputting the response comprises outputting a message to the external video conference provider including the response to cause the message to be received by the first client device.

20. The system of claim 16, wherein:
the LLM is a component of an agentic framework including one or more agents configured to perform one or more respective specialized tasks, wherein the agentic framework comprises a coordination mechanism that manages interactions between the one or more agents based on the expression; and
the response is generated by the agentic framework using the expression, the contextual information, and the additional information by:
determining an intent associated with the response;
selecting at least one agent of the one or more agents based on the intent and the contextual information;
instructing the selected agents to execute tasks to retrieve or generate additional content; and
generating the response using the additional content.
